(19) United States
(12) Patent Application Publication
(10) Pub. No.: US 2005/0029799 A1
(43) Pub. Date: Feb. 10, 2005

(54) Secure identification badge

(76) Inventors: Ron Collinson, Davidsonville, MD (US); Yoram Curiel, Norfolk, VA (US)

Correspondence Address: Law Offices of Royal W. Craig, Suite 153, 10 N. Calvert Street, Baltimore, MD, 21202, US

(21) Appl. No.: 10/910,131

(22) Filed: Aug. 3, 2004

Related U.S. Application Data
(60) Provisional application No. 60/492,406, filed on Aug. 4, 2003.

(51) Int. Cl. B42D 15/00

(52) U.S. Cl. 283/86

(57) ABSTRACT

A secure ID badge which incorporates metallic holographic imaging technology into the object metal surface. The hologram is embedded in a recessed surface of a metal object. Said recessed surface may already exist on the metal object, or be created by altering the die used to strike or cast the metal object to create the recessed surface. The hologram will be a customized size and shape. The recessed surface is of a size and shape able to accommodate the customized hologram. Such a hologram will be personalized in such a way as to identify this particular object against all other similar ones. The metallic side of the hologram is affixed to the metallic object, onto a recessed cavity using appropriately strong adhesive creating permanent bonding between the two devices. The bonding between the security device and the object body is such that the hologram self destructs if tampered with. An epoxy or other appropriate material may be applied as a dome over the hologram upper surface for added protection from tampering.

### CROSS-REFERENCE TO RELATED APPLICATIONS

The present application derives priority from U.S. Provisional Patent Application No. 60/492,406 filed Aug. 4, 2003.

### BACKGROUND OF THE INVENTION

1. Field of the Invention

The present invention relates generally to law enforcement badges and other badges and, more particularly, to a secure identification badge with tamper-resistant hologram to resist copying and prevent fraud.

2. Description of the Background

State and federal government officials have long used metallic identification badges, each of which have a unique visual appearance to identify the respective administration or agency. Indeed, the use of such badges is usually required by laws which require the bearer to wear the badge in such a way that the badges may be easily read while doing business. The same laws require that the license and identification badges shall be used only by the person to whom they were issued and may not be transferred to any other person. Nevertheless, this does not prevent criminals from committing consumer fraud using counterfeit badges. It is also difficult to differentiate between civilian private guards and the real official government badge carriers such as law enforcement, fire and rescue, military, or other officials. Counterfeit badges can be acquired quite easily directly from the manufacturer of the badge. Many of these manufacturers are located overseas and operate via the internet. These manufacturers are often willing to sell to anyone able to pay for their services, and their risk is minimal since they operate over the internet. Often the only difference between identical badges from the same manufacturer is a sequential number located on the badge, thus immediate verification is not practical or even possible.

Many administrators believe that identification badges are too easily counterfeited, and have even tried requiring the bearer's name and/or social security number to be stamped on the badges as an anti-fraud measure. However, police unions tend not to like such precautions, decrying them as an invasion of the officer's privacy. There remains, therefore, a substantial need for an improved identification badge which will facilitate avoidance of counterfeiting.

One of the inventors named herein has patented a method for producing an information article that virtually prevents replication, imitation and or duplication, and therefore is highly tamper resistant. U.S. Pat. Nos. 6,364,994 and 6,164,548 both to Curiel et al. teach a tamper resistant informational article utilizing metallic hologram technology. Curiel et al. place a hologram in an area with the information and secures a transparent tape having a write resistant exposed surface over both. The hologram resists photocopy duplication of the article and the write resistant tape resists alteration of the information.

It would be greatly advantageous to adapt the concept for security identification badges in order to provide a copy proof, highly tamper resistant badge to allow one to easily identify and authenticate any law enforcement, fire and rescue, military, or other federal officer badge, or even machine parts, automotive parts, firearms, and other metal parts.

### SUMMARY OF THE INVENTION

Accordingly, it is a principal object of this invention to provide a mechanism for verification of the authenticity of an identification badge which utilizes personalized hologram technology incorporated into any “First Responder” such as law enforcement, fire and rescue, military, or other federal officer badge, machine part, automotive part, firearm, or other appropriate application. Personalized hologram technology generally employs printed personal information that is patterned as a refractive hologram so as to resist reproduction by a form of photocopying. Efforts to photocopy, even on paper of identical color as the original form would fail to reproduce the personal information and thereby preclude photocopying as a means of counterfeiting. A personalized hologram may incorporate specific information about the individual wearing the badge, such as a picture of the wearer or other identifying information. In this way, the identification of the person can be easily verified using this highly visible personalized hologram. This personalized hologram technology incorporates the added feature of being immune from duplication. Specific applications of personalized hologram technology are set forth in U.S. Pat. Nos. 6,364,994 and 6,164,548 both to Curiel et al. described above.

Another object of the present invention is to provide a method of incorporating a hologram in any surface of appropriate dimensions to accommodate said identification.

Another object of the present invention is to provide an identification that is highly durable, completely immune from duplication, and quick to produce, thus facilitating mass application of the identification.

Another object of the present invention is to provide an identifying means in a form of purely metallic personalized image that ties the badge to a specific person. Such personalized image can be made of any metal, and be permanently secure to the surface of the badge.

Yet another object of the present invention is to make identification and authentication of the item in question fast and easy.

According to the present invention, the above described and other objects are accomplished by providing a security identification badge and method of making the same that utilizes metallic hologram technology currently used for manufacture of identification cards, as taught in U.S. Pat. No. 6,164,548 to Curiel et al. published on Dec. 26, 2000. Curiel et al. '548 teaches a method of creating a tamper resistant informational article utilizing metallic hologram technology. The present invention adapts this hologram technology to a portion of a 3D metallic object by formation of a recessed tamper-proof enclosure.

Other objects and advantages of the invention will become apparent from the following description of the embodiments taken in conjunction with the accompanying drawings.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a diagrammatic front view of a secure identification badge 2 with tamper-resistant hologram 4 embedded therein to resist copying and prevent fraud.

### DETAILED DESCRIPTION OF THE PREFERRED EMBODIMENT

The present invention is a secure identification badge and method of construction thereof with a duplication-proof metallic hologram, with optically overt and cover identifying features that are embedded in the badge for visual authentication of First responders. The hologram personalizes the badge with information that is specific and identifiable to the individual application. Each badge is manufactured for a specific application and is duplication proof and thus is non-transferable. Verification of the information contained in the hologram is easy as it is accomplished visually. Personalization may include the picture of the intended user, or any other personalized data, but is not limited to this form of personalization.

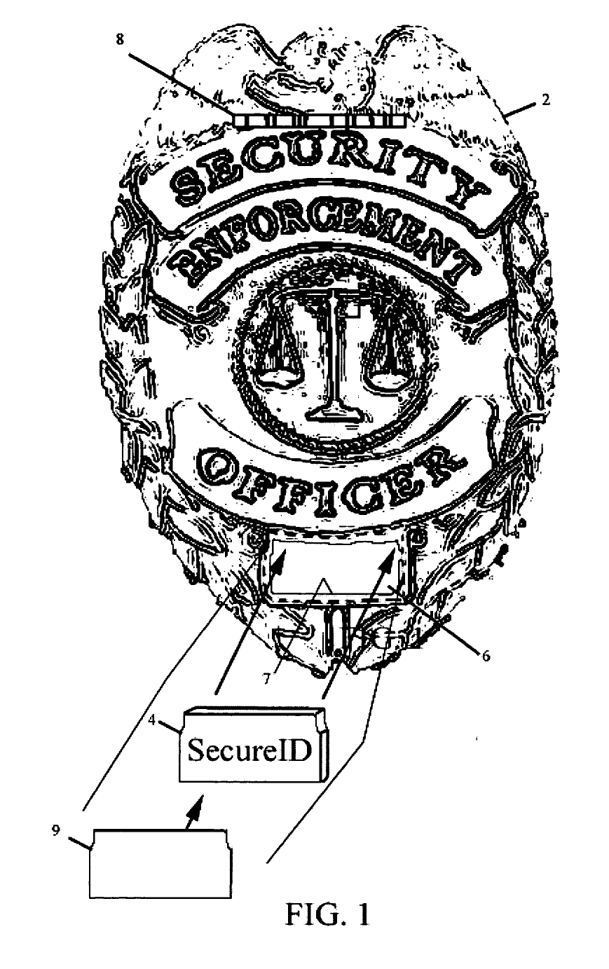

FIG. 1 is a diagrammatic front view of a secure identification badge 2 in accordance with the present invention, which generally incorporates a tamper-resistant hologram 4 embedded in badge 2 to resist copying and prevent fraud.

In the preferred embodiment the badge 2 is die-struck as die-striking creates a more durable product. However, the badge may be die-cast if necessary. To form the secure ID badge, the die is custom shaped to with a protruding block in order to strike or cast the badge (as shown) with depression 6. The depression 6 provides for a flat surface on the article onto which the personalized hologram 4 will be applied. The depression 6 is very slightly deeper and larger than the hologram 4, approximately 0.010 to 0.020 inches deep to accept a 0.008 to 0.018 inch hologram. The dimensions are necessarily close-tolerance so that the surface of the hologram 4 rests flush with the surface of the die-struck or die-cast badge 2 as this helps to prevent tampering. The hologram 4 is seated in recess 6 and is preferably bonded therein using an epoxy. This way, the hologram 4 self destructs if tampered with.

If desired, an epoxy or plastic dome or window 9 can be attached over the hologram 4 for added protection from tampering. In this regard, the recess 6 is preferably formed from the back of the badge 2 leaving an open aperture at the front, and a reverse flange 7 (shown in dotted lines) about the aperture to seat and restrain the window 9 and/or hologram 4. As before, the dimensions must be close-tolerance so that the surface of the window 9 rests flush with the surface of the die-struck or die-cast badge 2. The epoxy or plastic dome or window 9 is inserted into the recess from the back, and then the hologram 4 is seated in the recess 6 to show through the epoxy or plastic window.

It is noteworthy that rather than forming the die with a protrusion to create the recess 6, and then manually inserting the hologram 4, it is also possible to reform an existing die used to strike or cast the metal object to include a depression where the hologram can be seated, and then inserting the hologram into the die prior to casting.

The hologram 4 is a preferably a “parallax” hologram with the ability to cast an image and colors from many angles and depths. The colorful effect comes from microstructures within the hologram, which causes diffraction of the light hitting them. The hologram is preferably imprinted with information about the wearer, and may be visible only under certain types of light allowing for an additional level of security and verification. In this regard, the hologram 4 may be any 2-D or 3-D metallic OVD (optically Variable Device) including inks, thin films and foils, or DOVID (Diffractive optically variable image device) including proprietary devices such as Kinegram® and Exelgram®, whether 2D or 3D.

As seen in FIG. 1 a bar code 8, metallic strip, or other appropriate identification mechanism may be applied to the front or back surface of the metal object for additional informational and/or security access purposes.

In addition to its application to badges 2 as described above, the present invention contemplates application of a hologram may to any metal item upon which it is desired to place a security feature as described herein, so long as the metal item can be formed as described. Potential articles include machine parts, automotive parts, firearms, jewelry, or other articles that often are targets of fraud.

The invention may be embodied in other specific forms without departing from the spirit or essential characteristics thereof.

For example, in another embodiment, the protective device is comprised of a substrate with optically variable three dimensional surface, personalized data printed on top of this surface, and finally over coated with a layer of pure metal. This last metallic layer is then permanently affixed to the metallic based Badge.

In another embodiment, a very light weight badge is provided, by making the entire badge of thermoplastic material, by way of injection molding. After molding the badge, it is coated with pure metallic in a process similar to the one described as protecting the personalized data. The badge can be secured as described before.

The present embodiments are therefore to be considered in all respects as illustrative and not restrictive, the scope of the invention being indicated by the appended claims rather than by the foregoing description and all changes which come from within the meaning and range of equivalency of the claims are therefore intended to be embraced therein.

1. A secure identification badge, comprising:
a badge body die-formed with an aperture there through, said aperture being framed by a flange at a face of said badge body;
a flat metallic hologram seated behind the flange of said badge body to sit flush with the face of said badge body.

2. The secure identification badge according to claim 1, wherein a flat surface of the hologram rests flush with the face of said badge body to prevent tampering.

3. The secure identification badge according to claim 1, wherein said hologram reflects optically overt and cover identifying features unique to an intended wearer of the badge.

4. The secure identification badge according to claim 1, wherein said hologram is seated and bonded in said aperture by an epoxy so that the hologram self destructs if tampered with.

5. A secure identification badge, comprising:
a badge body die-formed with an aperture there through, said aperture being framed by a flange at a face of said badge body;
a transparent window seated behind the flange of said badge body to sit flush with the face of said badge body;
a flat metallic hologram seated behind said window for viewing there through.

6. The secure identification badge according to claim 5, wherein a flat surface of the window rests flush with the face of said badge body to prevent tampering.

7. The secure identification badge according to claim 5, wherein said hologram reflects optically overt and cover identifying features unique to an intended wearer of the badge.

8. The secure identification badge according to claim 5, wherein said hologram and window are both seated and bonded in said aperture by an epoxy so that the hologram self destructs if tampered with.

9. An article of manufacture having an embedded secure identification hologram, comprising:
a body formed with an aperture there through, said aperture being framed by a flange at a face of said body;
a flat metallic hologram seated behind the flange of said body to sit flush with the face of said body.

10. The article of manufacture according to claim 9, wherein a flat surface of the hologram rests flush with the face of said body to prevent tampering.

11. The secure article of manufacture according to claim 10, wherein said hologram reflects optically overt and cover identifying features unique to an intended application of the article of manufacture.

12. The secure identification badge according to claim 9, wherein said hologram is seated and bonded in said aperture by an epoxy so that the hologram self destructs if tampered with.

13. A secure article of manufacture, comprising:
a body die-formed with an aperture there through, said aperture being framed by a flange at a face of said body;
a transparent window seated behind the flange of said body to sit flush with the face of said body;
a flat metallic hologram seated behind said window for viewing there through.

14. The secure article of manufacture according to claim 13, wherein a flat surface of the window rests flush with the face of said body to prevent tampering.

15. The secure article of manufacture according to claim 13, wherein said hologram and window are both seated and bonded in said aperture by an epoxy so that the hologram self destructs if tampered with.

16. A method for providing a hologram on a metal object, comprising:
reforming the die used to strike or cast the metal object to include a depression providing an appropriate flat surface at the desired location on the metal object where the hologram can be applied; and
applying the prior art hologram onto the provided flat surface.

17. The method of claim 16 wherein said reforming step includes making the depression in the die a custom shape for accommodating the custom shaped hologram.

18. The method of claim 16 wherein said reforming step includes making the depression in a range of from 0.010 to 0.020 inches deep.

19. A method for providing a hologram on a metal object, comprising:
forming a die used to strike or cast a metal object with a protrusion to define a two-tier aperture through the metal object where the hologram can be seated; and
casting a metal object by use of the die;
bonding the hologram against a smaller tier of the two-tier aperture.

20. The method of claim 19 further comprising the step of bonding a transparent window over said hologram.
